(19) United States
(12) Patent Application Publication
(10) Pub. No.: US 2005/0068915 A1
(43) Pub. Date: Mar. 31, 2005

(54) Wireless infrastructure for broadcasting with return channel

(75) Inventors: Efraim Atad, Tel Aviv (IL); Ofer Harpak, Kiryat Tivon (IL); Eitan Efron, Yaaf (IL)

Correspondence Address: G.E. EHRLICH (1995) LTD.;c/o ANTHONY CASTORINA, SUITE 207, 2001 JEFFERSON DAVIS HIGHWAY, ARLINGTON, VA, 22202, US

(73) Assignees: WI Networks Inc.; WI Networks Ltd.

(21) Appl. No.: 10/810,552

(22) Filed: Mar. 29, 2004

Related U.S. Application Data
(60) Provisional application No. 60/501,411, filed on Sep. 10, 2003.
(60) Provisional application No. 60/515,441, filed on Oct. 30, 2003.

(51) Int. Cl. H04B 7/185

(52) U.S. Cl. 370/316

(57) ABSTRACT

Infrastructure for interactive broadcasting is provided using a wide area network for bi-directional transmission between a plurality of user nodes and a central source node, at least some of the user nodes comprising rooftop video broadcast receiving installations modified with a terrestrial bi-directional antenna and network transmission support electronics.

### RELATIONSHIP TO EXISTING APPLICATIONS

The present application claims priority from U.S. Provisional Patent Application No. 60/501,411 filed Sep. 10, 2003 and U.S. Provisional Patent Application No. 60/515,441 filed Oct. 30, 2003.

### FIELD AND BACKGROUND OF THE INVENTION

The present invention relates to wireless infrastructure to provide the return or interactive channel for broadcasting with a return channel, either via (DVB-S) or via (DVB-T) or in any other way, and, more particularly, but not exclusively to a method and apparatus for providing broadband services, interactive TV and gaming, broadband Internet access and internet telephony, full duplex, three-way communication and like services requiring at least a return channel to satellite or terrestrial television customers. Currently, cable operators are able to provide their customers with interactive television, Internet telephony and broadband Internet services. Satellite operators however are limited in that it is impractical to provide a return channel via satellite link. Nevertheless, if satellite providers wish to attract customers then they have to be able to compete with the packages offered by the cable companies.

A number of prior art systems have been proposed to overcome the above problem and provide at least a return channel for the satellite customer. One proposal currently being adopted by satellite providers is to incorporate a telephone modem into the customer's decoder box. When the customer attempts to use interactive TV then the modem dials a service number and establishes a telephone connection. The system has a number of disadvantages. For example it cannot be used whilst the user's telephone line is engaged and additionally there is a call charge to be made to the telephone provider. Furthermore such a service cannot provide broadband Internet.

Another solution is disclosed in U.S. patent application Ser. No. 09/811,593 which describes two-way data communication via satellite, using data communication in a first direction via satellites in geostationary orbit, and data communication in a second direction via satellites in a below geostationary orbit, either MEO or LEO. The transceiver is described as being particularly useful for providing Internet connections although the application of Interactive TV is not specifically mentioned. Preferably, a LEO forward link is used for control signaling, urgent data traffic and the like. The disadvantage of this solution however is that LEO satellites require directional antennas and even for MEO the user's satellite dish has to be modified considerably or replaced in order to provide the necessary transmission power. Furthermore the satellite provider has to make sure that transmission capacity is continuously available from MEO satellites. The solution is not economical, both the bandwidth and the necessary customer units are expensive.

Additional patents and applications relate to the application of providing a return channel to DBS, manly over PSTN line or two-way satellite connection. See, for example, U.S. Pat. No. 20020004369; System and method for managing return channel bandwidth in a two-way satellite system; U.S. Pat. No. 20010043575 System and method for providing a two-way satellite system or U.S. Pat. No. 6,473,903: Method and system for implementing interactive broadcast programs and commercials or U.S. Pat. No. 6,515,680 Set top terminal for television delivery system. See also U.S. Pat. No. 20020049038 Wireless and wired cable modem applications of universal frequency translation.

Despite its popularity, there is slow deployment of broadband access (less than 20% coverage in the USA), mainly due to the limited coverage of xDSL capability and cable.

At the same time the demand for wireless access is growing and there are currently over 2400 wireless ISPs in the USA.

The success of WiFi (Wireless LAN) proves the demand of wireless access, but is limited to the short range so-called SOHO market. Existing long-range wireless solutions, for example LMDS, MMDS, and the 3G (third generation cellular) are limited in functionality. That is to say they currently suffer from the disadvantages of being asymmetric, and providing relatively low-speed data transfer. Consequently they provide poor support for low-latency applications, although they are optimal for voice. The services are relatively expensive to deploy and therefore currently almost non-existent.

There is thus a demand for a standardized and cost effective Metro Wireless Network to complement the WiFi solution.

To do so there is a need to move from today's fixed, line-of-site, voice centric technology to new mobile, non-line-of-site and data centric wireless standards such as IEEE 802.16 and IEEE 802.20.

The Satellite TV or DBS market presents a huge customer base. In 2003 there are over 100 million satellite digital set top decoder boxes (STB) providing Conditional Access (CA) in circulation and over 100 million satellite free to air STB's. By 2006 the market is expected to grow to over 350M CA digital STB's. In addition, DVB T penetration is growing with over seven hundred thousand STB's in the UK only.

The DBS market and technology for DBS is the focus of the present embodiments, although it will be appreciated that the technology is equally applicable to terrestrial broadcasting.

DBS providers have to compete with terrestrial networks and particularly with the cable networks who are able to provide broadband Internet, interactive TV, video on demand, games on demand and the like over their infrastructure.

The lack of an effective return channel and unicast support for DBS are a serious limitation on the growth and provisioning of new services—causing loss of market share and potential revenues from existing customers.

A return channel of some kind is required to support interactive television and a unicast channel is required to support revenue-generating services such as VOD. VoIP, and Internet access. The difficulty that needs to be overcome is finding an effective way to provide such a return channel and unicast support in association with satellite broadcasting.

The lack of a natural return channel force DBS providers to cooperate with telephony providers to solve the problem using a modem and telephone link as explained above. However the telephone return channel is paid for separately, is costly if used extensively and restricts availability of the user's telephone line.

Other solutions for return channel or unicast services support include satellite return (e.g. VSAT, ARTES) but the options are limited and the solutions are not economical.

Customers are looking for one-provider-one bill, just as they currently receive from the cable providers. DBS providers are under pressure to become a full MSP (multi-Service Provider) and support the full range of services that customers are able to obtain from competitors. Table 1 shows various schemes for broadband data transmission and tabulates their usability for various types of media.

TABLE 1
Broadband Network Status for MSP support

| | Cable | XDSL | 3G | FTTH | DVB T | Satellite |
|---|---|---|---|---|---|---|
| Voice | Yes | Yes | Yes | Yes | No | No |
| Data | Yes | Yes | Yes/No | Yes | No | No |
| Video | Yes | No | No | Yes | Yes | Yes |
| VOD | Yes | Yes | No | Yes | No | No |
| RC | 128 kb | 128 kb | 40 kb | ˜ | No | No |
| Cost | $ | $ | $ | $$$ | | |

It is clear from table 1 that satellite as such is currently unable to provide any service that requires interactivity and/or a return channel. Furthermore triple play is limited to multi channel television.

The 2002 Military Communications Conference Proceedings Vol. 1 2002 PP 178-183—Satellite Terrestrial Broadcast System for Deployed Communications—Nato Consultation Command & Control Agency, The Hague Netherlands, discusses the use of satellite digital video broadcasting as a feeder source for a WAN network to provide video signals for mobile deployed units. A small capacity return channel is also available via the WAN. The paper is aimed at mobile users and the application of the system to satellite TV subscribers is not immediately apparent since the subscribers receive the satellite signal directly.

There is thus a widely recognized need for, and it would be highly advantageous to have, a vehicle inspection system devoid of the above limitations.

### SUMMARY OF THE INVENTION

According to one aspect of the present invention there is provided a wide area network for bi-directional transmission between a plurality of user nodes and a central source node, at least some of the user nodes comprising rooftop video broadcast receiving installations modified with a terrestrial bi-directional antenna and network transmission support electronics.

Preferably, at least some of said user nodes comprise support for hotspot functionality, thereby to allow mobile communication devices to access said wide area network system.

Preferably, said support for hotspot functionality substantially comprises standard IEEE 802.11.

Preferably, said rooftop video broadcast receiving installations are satellite receiving installations.

Alternatively said rooftop video broadcast receiving installations are terrestrial broadcast receiving installations.

According to a second aspect of the preset invention there is provided a wide area network system, comprising:
a central source node,
a plurality of base nodes connected via cable infrastructure to said central node, and
a plurality of user nodes, at least some of the user nodes comprising rooftop video broadcast receiving installations modified with a terrestrial bi-directional antenna and network transmission support electronics.

Preferably, the cable infrastructure is hybrid fiber coax (HFC) infrastructure.

Preferably, a wide area network transmission standard is used over said cable infrastructure.

Preferably, said transmission standard is at least one of IEEE 802.16 standard or the IEEE 802.20 standard.

Preferably, at least some of said user nodes comprise support for hotspot functionality, thereby to allow mobile communication devices to access said wide area network system.

Preferably, said support for hotspot functionality substantially conforms to IEEE standard 802.11.

Preferably, said rooftop video broadcast receiving installations are satellite receiving installations.

Alternatively, said rooftop video broadcast receiving installations are terrestrial broadcast receiving installations.

According to a third aspect of the present invention there is provided a hybrid cable and wireless bidirectional transmission network comprising a wireless network part and a cable part and wherein a wide area network transmission standard is used over both said wireless network part and said cable part.

Preferably, said transmission standard is at least one of IEEE 802.16 standard or the IEEE 802.20 standard.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps automatically. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer, or by a CPU placed within a set top box or like device using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram showing a general concept of the present embodiments, namely of a user satellite receiver installation for receiving a satellite feed and also forming a node of a terrestrial WAN;

FIG. 2 is a simplified diagram showing how an existing installed cable at the user satellite receiver installation is sufficient for a receiver installation augmented according to the present embodiments to incorporate WAN functionality;

FIG. 3 is a simplified diagram showing a modification of the embodiment of FIG. 2 in which WAN customer premise equipment is integrated with a splitter combiner in a single housing;

FIG. 4 is a simplified diagram illustrating a modification of the installation of FIG. 2 for use in a multi-occupancy building;

FIG. 5 is a simplified diagram illustrating a filter-only connection for a user in a multi-occupancy building who does not require a return channel;

FIG. 6 is a simplified diagram illustrating alternative connections to a central feed for users in a multi-occupancy building who require a return channel;

FIG. 7 is a simplified diagram illustrating a system using one TV frequency band and two WAN frequency bands;

FIG. 8 is a simplified diagram illustrating a system using one TV frequency band, two WAN frequency bands and two WiFi or hotspot frequency bands;

FIG. 9 is a simplified schematic diagram of a rooftop satellite receiver installation showing two options for mounting a modification to equip the antenna for WAN and if required for hotspot use;

FIG. 10 is simplified diagram showing in more detail the modification options illustrated schematically in FIG. 9;

FIG. 11 is a simplified diagram showing the modifications of FIG. 9 viewed from the front of the antenna;

FIG. 12 is a simplified diagram illustrating the modifications of FIG. 9 viewed from the side of the antenna;

FIG. 13 is a simplified schematic diagram illustrating a system for integrated broadcasting and service management of a satellite link and a WAN two-way interactive channel;

FIG. 14A is a simplified diagram of a user installation for supporting satellite broadcasting according to the various embodiments of the present invention;

FIG. 14B is a simplified diagram of an example user installation that supports Ethernet as a distribution medium from the roof unit to the home and from the home gateway to the STBs;

FIG. 15A is a simplified diagram illustrating in schematic form the system of FIG. 13;

FIG. 15B is a block diagram illustrating in greater detail a configuration that retains compatibility with existing the Telco or telephone line solution;

FIG. 16A illustrates a residential gateway device supporting a set top box according to a preferred embodiment of the present invention;

FIG. 16B illustrates a configuration in which the set top box and residential gateway are combined as a single device;

FIG. 16C illustrates a configuration in which a residential gateway supports a number of devices including a set top box;

FIG. 16D illustrates a configuration in which a combined set top box and residential gateway supports a television and other household communication enabled devices;

FIG. 16E illustrates a configuration in which a combined set top box and residential gateway supports a number of standard set top boxes;

FIG. 17A illustrates a WAN formed from a plurality of satellite receiver installations and in which meshwise connections are available making several paths available to reach groups or individual users;

FIG. 17B illustrates use of a backhaul channel between two WAN base stations;

FIG. 17C illustrates use of a repeater to support a backhaul channel;

FIG. 17D illustrates use of a local center and multiple repeaters to feed individual base stations;

FIG. 18 illustrates the WAN of FIG. 17 in which the individual satellite installations of the WAN support local hotspots;

FIG. 19 is a system diagram illustrating a WAN and hotspot supporting equipment arrangement from a system point of view;

FIG. 20 is a system diagram illustrating a residential gateway according to a preferred embodiment of the present invention from a system point of view;

FIG. 21 illustrates the residential gateway of FIG. 20 connected to a set top box also shown from a system point of view;

FIG. 22 illustrates a residential gateway integrated with a set top box according to a preferred embodiment of the present invention;

FIG. 23 is a system diagram showing the DBS head end of FIG. 13 shown from a system point of view;

FIG. 24 is a simplified diagram showing a cable-based distribution system adapted in accordance with embodiments of the present invention;

FIG. 25 is a simplified diagram illustrating a terrestrial broadcast system adapted in accordance with embodiments of the present invention, and

FIG. 26 is a simplified diagram illustrating a hybrid cable and terrestrial broadcast distribution system adapted in accordance with embodiments of the present invention.

### DESCRIPTION OF THE PREFERRED EMBODIMENTS

The present embodiments comprise a satellite (DVB-S) or terrestrial (DVB-T) based broadcasting system in which a digital TV feed is provided over a satellite or terrestrial connection to a user's receiver and wherein a 2-way preferably relatively high data rate channel is provided over a WAN which uses each receiver as a micro-base station for the WAN network. The WAN network may be mesh configured so that multiple paths exist for transmitting to each user, hence making it more robust. This may be best achieved simply by using the DBS install base. The WAN provides at least a return channel to enable interactive television and like services but may also provide an outward channel of high capacity allowing unicast. Thus services such as Internet, Internet telephony and video/gaming on demand can be made available.

It will be appreciated that whilst the present embodiments concentrated on DBS, or more precisely DVB-S (digital video broadcast via satellite) the invention is as much applicable to DVB-T (digital video broadcast—terrestrial), in which return and interactive channels can be applied in the same way to the existing broadcast channel.

The WAN is preferably based on the WiMax (IEEE 802.16) standard, or alternatively on the IEEE 802.20 standard and/or on the DVB-T standard.

The IEEE 802.16 addresses the “first-mile/last-mile” connection in wireless metropolitan area networks. The 802.16 standard creates a platform on which the present embodiments are able to build a cost-effective broadband wireless solution which is high-speed and which uses the existing satellite receivers as an infrastructure so that it can be installed rapidly and cheaply.

The IEEE 802.16 or WiMax standard was approved on April 2002, after a two-year, open-consensus process that involved the world's leading operators and vendors. IEE 802.16 enables interoperability among devices from multiple manufacturers.

The standard is purely packet based and thus is eminently suitable for data-based services. It includes a medium access control layer (MAC) that supports multiple physical layer specifications. The physical layer supports a wide-range band coverage (licensed and unlicensed) including band 10 to 66 GHz (802.16c) and band 2 to 11 GHz (802.16a). IEEE 802.16e is the mobile version. Although the standard covers a very large spectrum it specifically targets the 2.4 Ghz, 3.5 Ghz, and 5.8 Ghz bands and also targes operation of the 6-20 Mhz bands. There is also interest in the use of KU bands 12.2-12.7 Ghz, currently reserved for southbound sky use. This is a 500 Mhz band and may be considered for WAN and mobile use.

The IEEE 802.16 standard provides up to 50 Kilometers of linear service area range and enables connectivity without a direct line of sight to a base station. The technology also provides shared data rates of up to 70 Mbps, which, according to WiMax, is enough bandwidth to simultaneously support more than 60 businesses with T1-type connectivity and hundreds of homes.

In addition, it is possible to transmit WiMax over cable, and this can for example be used as a distribution method for reaching base stations. WiMax can then be used to extend Cable networks HFC (Hybrid Fiber Coax) to remote locations. The extension involves using WiMax over the cable part of the connection and then using wireless Wimax. Thus, from the HFC edge, wireless can connect to a Wimax base station and the HFC network can thus be extended to a remote rural area at a fraction of the cost of having to lay cable in the conventional manner.

It is further possible to extend Wimax back over the cable networks to the transmission source or headend.

Coax construction may be applied from the cable modem to the roof over coax/DSL or another—for the purpose of delivering a WiMAx service using the coax infrastructure, or from a Wimax supporting Cable STB—for supporting home devices, or from any means of delivering wimax over cable coax in addition to existing signals. The coax construction may be alternatively a totally separate delivery network from the headend, or from a fiber node, or from a coax node (such as the home units). Wimax support can be integrated in the cable STBs or be a separate residential gateway connecting to the Cable coax network. The WiMax support can be local, say an NLOS embedded antenna, or via an external antenna.

Furthermore there are provided composite WiMax cable networks which are able to combine the advantages of both coax and fiber.

More particularly, in addition to supporting DVB-T and DVB-S networks, WiMax can also be used to extend Cable networks HFC (Hybrid Fiber Coax) services to remote and underserved locations for a quick and low cost installation. The extension involves extending the network via WiMax wireless WAN to the customers homes or between MAN areas. At the HFC edge node (e.g. Fiber node), the bi-directional HFC information (content and signaling) will be converted to native IP format and inserted to the WiMax base station through a standard interface (e.g. Ethernet) for delivery over the WiMax network. On the return path the signals are converted from the Wimax network to the HFC network for transmission back to the headend. The network construction allows the Cable operator to operate VOD, internet access and internet telephony and extend existing capabilities of his current service structure.

Cable network can also serve as IP based core infrastructure for transmitting independent WiMax network signals from remote sight to a central location.

Returning to WiMax itself and the 802.16 standard makes highly efficient use of bandwidth and supports voice, video and data applications with enhanced support of quality of service.

The standard is used in setting up the WAN and provides the physical and access layers needed to provide a two channel link that is powerful enough to support interactive television and supply Internet at broadband levels.

The preferred embodiments provide systems and a method to implement return channel functions and unicast services to multi-channel TV DBS/DVB users and service providers using metro wireless packet radio, typically the above described IEEE 802.16 but also 802.20. It will be appreciated that the standards are not mandatory, and in certain jurisdictions may be modified by local regulations. The standards are also subject to amendment during the life of the patent. The skilled person will appreciate that in certain cases he is obliged to use the standards as given and in certain cases he may modify the standards or use them merely as guidelines for the kind of service to be provided.

The present embodiments allow satellite TV (DBS) providers that are limited today to multi-channel TV services to turn into multi-service providers (MSPs), and the present disclosure explains concepts, methods, technology, systems, and tools for a DBS service provider to cost-effectively turn into a MSP. The resulting system is preferably triple play and mobile ready.

The presently preferred embodiments between them comprise the following features and aspects of the invention:
A satellite-based channel feed operated together with a return channel and preferably with a full-duplex terrestrial broadband channel. Preferably the terrestrial return channel is a WAN and may be based on one or more of the wireless standards discussed herein. The WAN may additionally provide a forward channel.
The use of a satellite dish infrastructure as available from existing satellite users, as WAN nodes. The nodes may be WAN base-stations or WAN repeaters or simply receiver stations. In addition the satellite receivers may be used as micro base stations for hotspots, particularly using the IEEE 802.11 standard.
A set top box (or satellite decoder box) that has a single antenna outlet is adapted with a splitter/combiner (often termed dyplexer) to send and receive WAN traffic and to receive satellite traffic over the single outlet (3-way). The receiver may additionally manage local hotspot traffic (5-way).
A satellite dish has a WAN antenna, a splitter and combiner and a single outlet. The splitter combiner modulates the WAN and satellite signals so that they can be sent through the single cable and so that WAN signals can be received from the cable for broadcasting. The WAN infrastructure preferably also allows the WAN antenna to serve as a relay for traffic not intended for the local user so that the WAN forms a mesh giving multiple communication pathways to individual users, and enables the WAN to span higher distances yet transmit at lower power. The modified antenna may also provide a micro-base station for a local hotspot.
A head end or broadcast station supports a one-way data streaming channel which is broadcast via satellite and a two-way terrestrial channel for a return link to support interactive services. An outward terrestrial channel can also be provided. The combination allows for unicast signals to be sent to individual users, and allows interactive TV, Internet, telephony via voice over IP (VoIP) and like services.—As will be explained below the system may further accommodate mobile services according to the IEEE 802.16e or 802.20 standards.
A method of adaptation of an existing satellite dish by adding a splitter/combiner and a terrestrial antenna. The adaptation allows the dish to support both the satellite and terrestrial channels without making any changes to the connection between the satellite dish and the user's internal devices.
A household communication hub has a bidirectional output to a satellite dish, and bidirectional outputs to household appliances or a household LAN. The hub includes or is connected to a splitter combiner unit for modulating the WAN and satellite signals as above.

The principles and operation of a satellite system with return channel according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

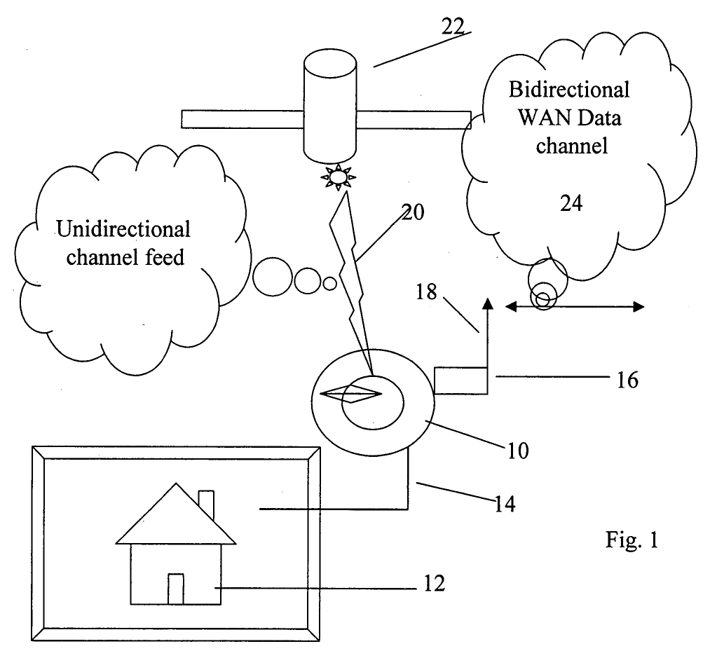

Reference is now made to FIG. 1, which is a simplified diagram illustrating a satellite broadcast system with terrestrial WAN support according to a first preferred embodiment of the present invention. A satellite customer has a satellite dish 10 on the roof of his house 12. The satellite dish is linked to a set top decoder or set top box (STB) in the house 12 by a single cable, typically a co-ax cable 14 in the usual way (Typically RG6, RG11 or RG59 coax cables). Indeed it is a preferred feature of the present embodiment that the cable is not modified when upgrading satellite TV receivers as this makes the upgrading process simpler and therefore cheaper. The satellite dish is modified with a splitter combiner unit 16, miscellaneous supporting electronics as needed, and a terrestrial antenna 18. The unit on the roof may be in the same housing as the WAN antenna or may be separate.

The splitter combiner function can transmit the WAN signal over different bands either as RF, IF or Ethernet over the coax cable 14, and these variations should be borne in mind in the following drawings.

The satellite dish itself receives a multi-channel video feed 20 from satellite relay 22 which is typically in geosynchronous orbit. The terrestrial antenna 18 sends and receives radio signals 24 of a bidirectional wireless WAN using any of the standards mentioned above or based on modifications or variations thereof. Thus the satellite dish typically serves as a receive-only device just as with a prior art satellite TV receiver, whereas the terrestrial antenna provides a high capacity two-way channel. Indeed, as will be described below, the terrestrial antenna and supporting electronics in fact not only send and receive signals of the local satellite customer. As will be explained in greater detail below, they also serve as a relay station for passing signals between other satellite customers so that in effect a mesh is set up using the satellite infrastructure as a series of relays permitting higher transmission distances for lower transmitted power the green effect. In addition the individual antennas may serve as micro base stations to support local hotspots under IEEE 802.11.

The splitter combiner 16 combines the incoming signals from the terrestrial and satellite antennas to send down the cable 14 and directs outgoing signals from the cable 14 to the terrestrial antenna.

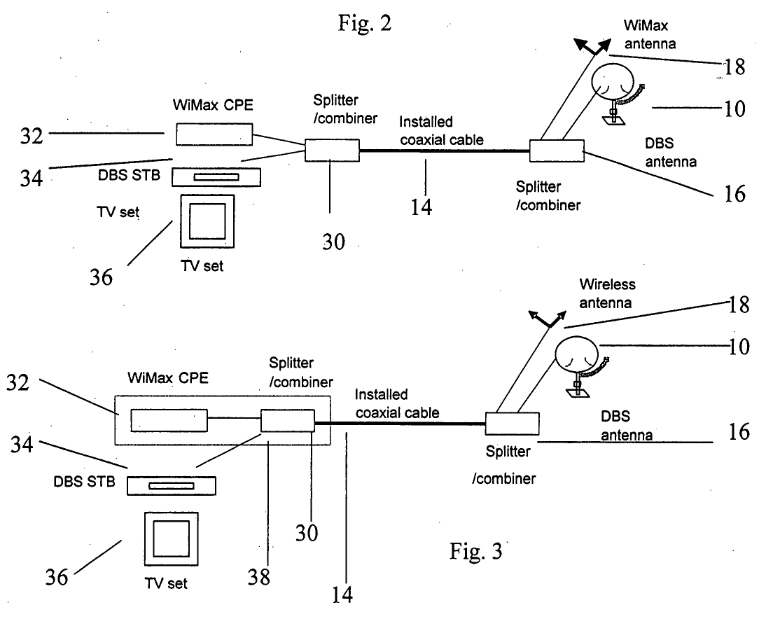

Reference is now made to FIG. 2, which is a simplified diagram illustrating the pathway from the set top box to the antenna according to a preferred embodiment of the present invention. Parts that are the same are given the same reference numerals and are not described again except as needed for an understanding of the present drawing. Again the satellite dish 10 and the terrestrial antenna 18 are located together on the outside of the building followed by splitter/combiner 16. The dish and antenna can also be separate if desired. A combined signal is transmitted through cable 14 and at the inside end of the cable is a further splitter combiner 30 which splits the incoming signals and combines the outgoing signals for transmission down the cable. The splitter combiner 30 is connected to a customer premises equipment (CPE) unit 32 which contains electronics for managing the wireless technology of the terrestrial network and for using it, both for sending and receiving data and preferably also for relaying data not intended for the local recipient. The local unit is also connected to the standard STB 34 which is in turn connected to television set 36. The set top box is a conventional satellite TV STB and carries out functions such as D/A conversion of digital channels and decoding of the incoming channels in the standard manner.

Reference is now made to FIG. 3, which is a modification of the embodiment of FIG. 2 in which the indoor-end splitter combiner and the CPE are combined into a single unit 38. The modification is simply an integration of the two within a single housing. Parts that are the same as in previous figures are given the same reference numerals and are not referred to again except as necessary for understanding the present drawing. The use of a single unit is aesthetically important as it reduces clutter at the indoor end.

A further possibility is to split the signal from the roof-top unit to the home units via wireless technology (e.g. using a WLAN based on IEEE standards 802.11, 16, 15. This is useful if there is no installed coax cable or the coax cable cannot be used for any reason.

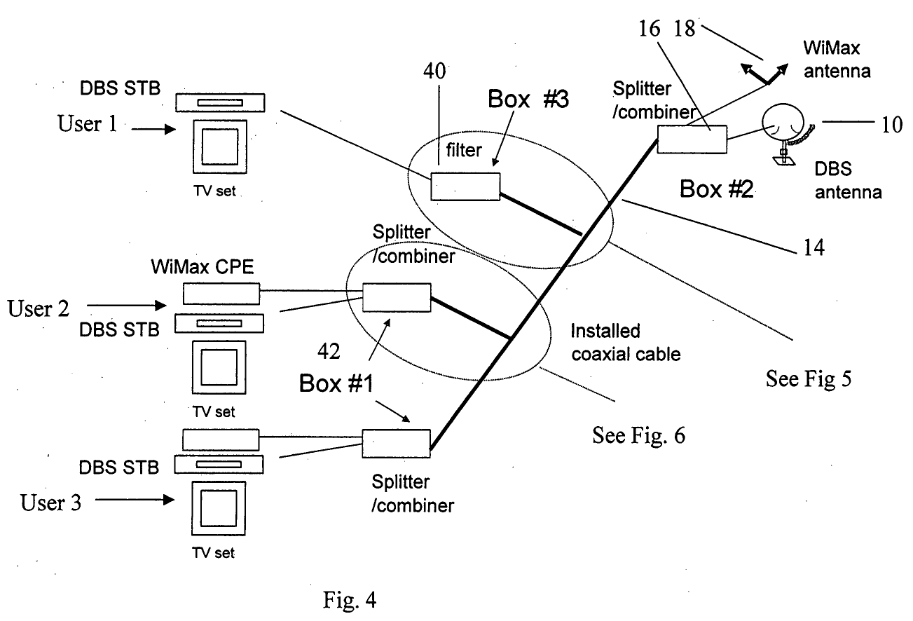

Reference is now made to FIG. 4, which is a simplified diagram illustrating a modification of the connection between the antenna and the STB for a multi-tenant building. Parts that are the same as in previous figures are given the same reference numerals and are not referred to again except as necessary for understanding the present embodiment. The skilled person will be aware that it is common to have a single receiver for all users in a multi-occupancy building. The skilled person will also be aware that in such a building, not all the users will require the maximum offered levels of service. FIG. 4 shows a scheme for distributing the signal from the antenna to all the users in the building and providing interactive channel functionality to those who require it. User 1 does not want interactive services and simply requires a satellite TV signal. User 1 is therefore supplied with filter 40 which filters out any signals to do with the WAN system and allows through the TV signal. Users 2 and 3 however require the interactive services and therefore are supplied with splitter combiners 42 which are connected to the common supply cable 14. All of the connections of the cable are supplied with terminations that enable them to take either the filter or the splitter combiner.

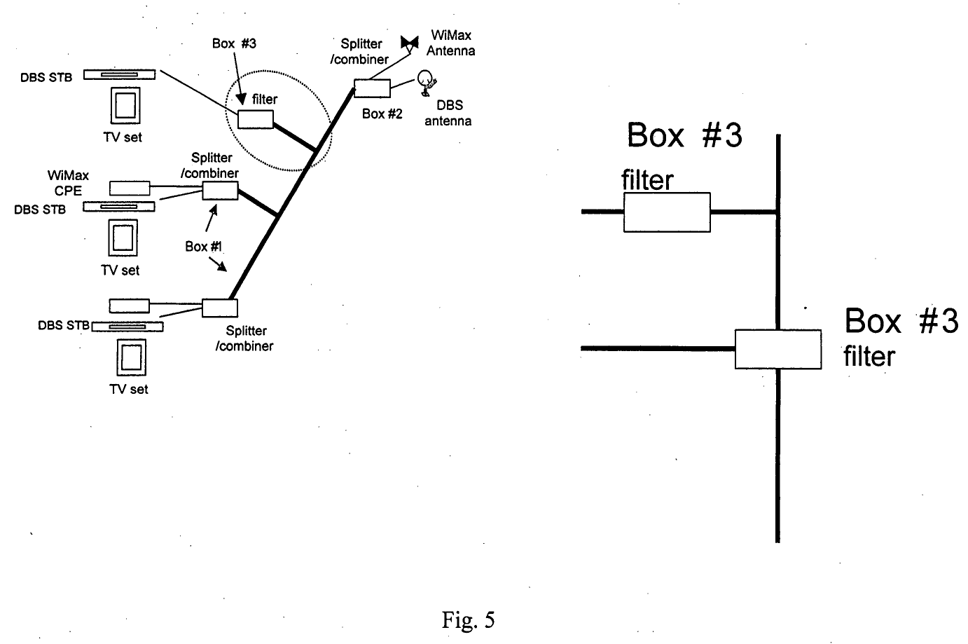

Reference is now made to FIG. 5, which is a simplified diagram illustrating in greater detail the filter connection to user 1 who does not require interactive services. The filter operates to filter out the WAN signals as described above so that the user does not receive them. It is noted that the filter may be located at the branch of the co-ax cable, in which case only a single filter is required. Alternatively the filter may be placed after the branch, in which case a second filter may be required.

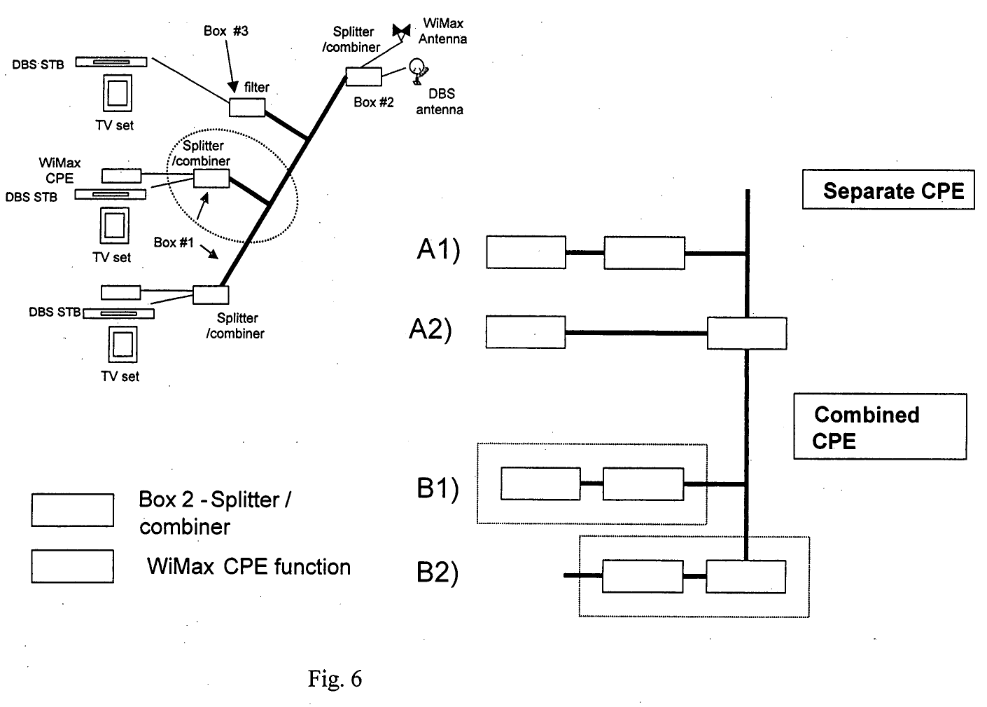

Reference is now made to FIG. 6, which is a simplified diagram illustrating in greater detail the filter connection to users 2 and 3. Again the splitter combiner may be located at the co-ax branch or may be located subsequent to the branch, in which latter case two may be required. The figure shows connections both for discrete and combined versions of the CPE and splitter combiner.

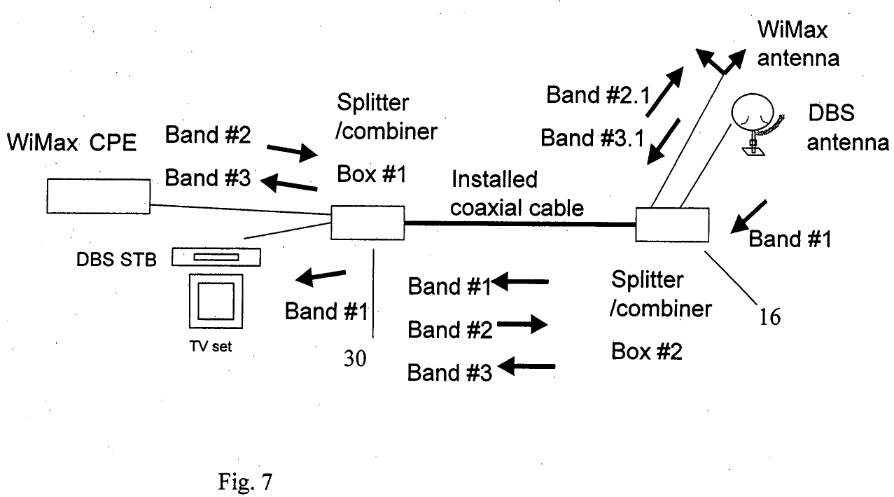

Reference is now made to FIG. 7, which shows the different frequency bands that appear at various points along the connecting wires between the antennas and the set top box. A first frequency band 1 is reserved for the incoming television signal from the satellite. The band is not changed and simply is picked up at the satellite dish and transferred to the set top box. A second frequency band, band 2 is used as an up band for outward broadcasting over the terrestrial antenna. The band is modified at the upper splitter combiner 16 to form band 2.1 in which band it is transmitted. Incoming signals are received at a band 3.1 and modified at upper splitter combiner 16 to form a band 3. Band 3 is transferred down the co-ax cable 14 and provides the incoming signals to the CPE.

The lower splitter combiner 30 is preferably transparent to band 1 but presents a high pass (or low pass) filter towards the STB and a band pass filter towards the CPE to ensure that each component receives the correct signal. The upper splitter combiner 16 is preferably also transparent to band 1 and includes an IF to RF converter for converting between bands 2 and 3 and bands 2.1 and 3.1. It includes an antenna termination for the antenna and a cable termination for the co-ax cable.

It is noted that it is possible to send an RF signal directly over the coax cable 14. In addition any combination of low/high/band pass is possible, and, as mentioned above an Ethernet over coax interface can be provided for the roof top unit and the CPE unit to allow Ethernet for the cable connection.

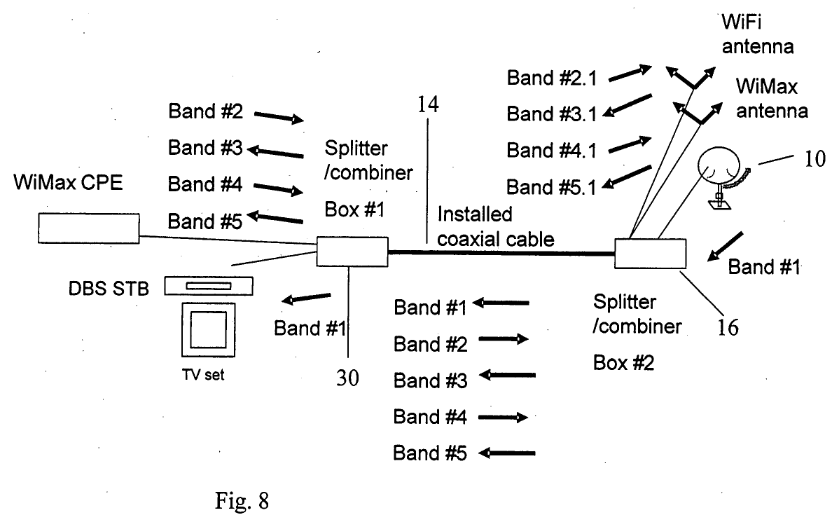

Reference is now made to FIG. 8, which is a simplified diagram illustrating a variation of the embodiment of FIG. 7 for additionally supporting WiFi hotspot functionality. The system is modified by adding two more bands, bands 4 and 5, received/transmitted as bands 4.1 and 5.1, over the terrestrial antenna. The new bands allow the accommodation of third party signals which are not intended for the user but instead allow his receiver to be used as a micro base station for relaying hot spot signals to nearby mobile communication devices. The third parties may be any users with communications equipment who are in range and are able to log in to the system, allowing the WAN to provide wireless hotspots in the local vicinity.

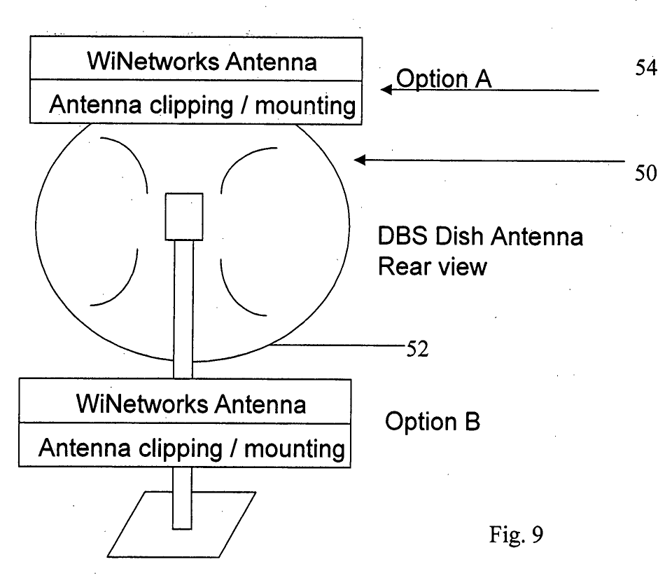

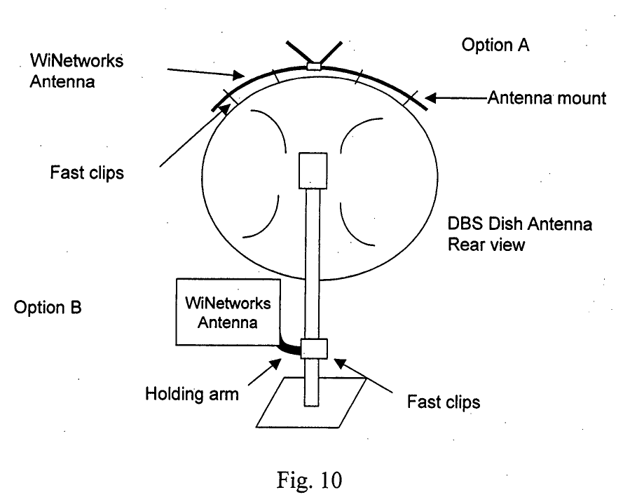

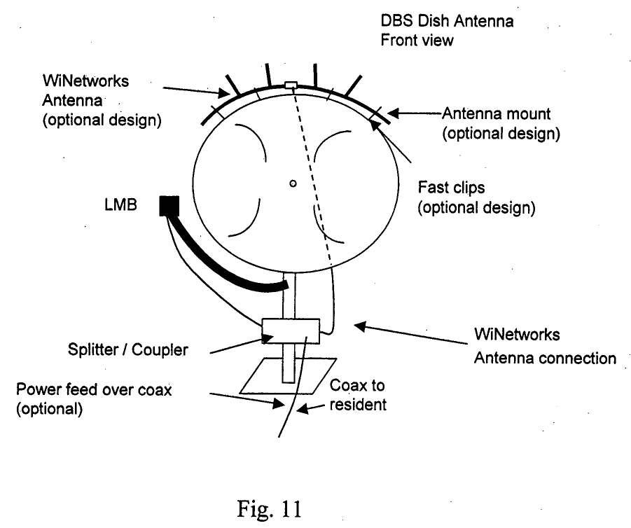

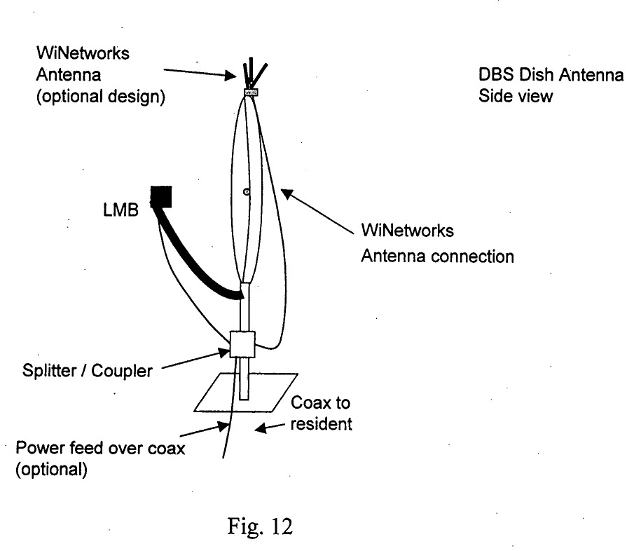

Reference is now made to FIG. 9, which is a schematic diagram illustrating two possibilities for attaching the WAN hardware to a satellite dish 50. The satellite dish has a stem 52 to which it is connected to the roof or wall of a building. The dish also has a peripheral end 54. The WAN hardware including the terrestrial antenna is preferably attached either to the stem 52 or the peripheral end 54. Whichever of the two options is used the antenna is mounted using an appropriate type of clip. The skilled person will appreciate that it is possible to place the antenna anywhere else on the roof or house wall if the line-of-site transmission requires higher distances. Alternatively the splitter/coupler may always be mounted on the stem, and the antenna may then be placed either together with the splitter coupler on the stem or the antenna may be separately mounted on the periphery of the dish. FIG. 10 is a rear view of the antenna showing both options in greater detail. FIGS. 11 and 12 are front and side views respectively of the options for mounting the antenna on the periphery of the dish with the splitter coupler on the stem. The splitter coupler is connected via a cable to the terrestrial antenna.

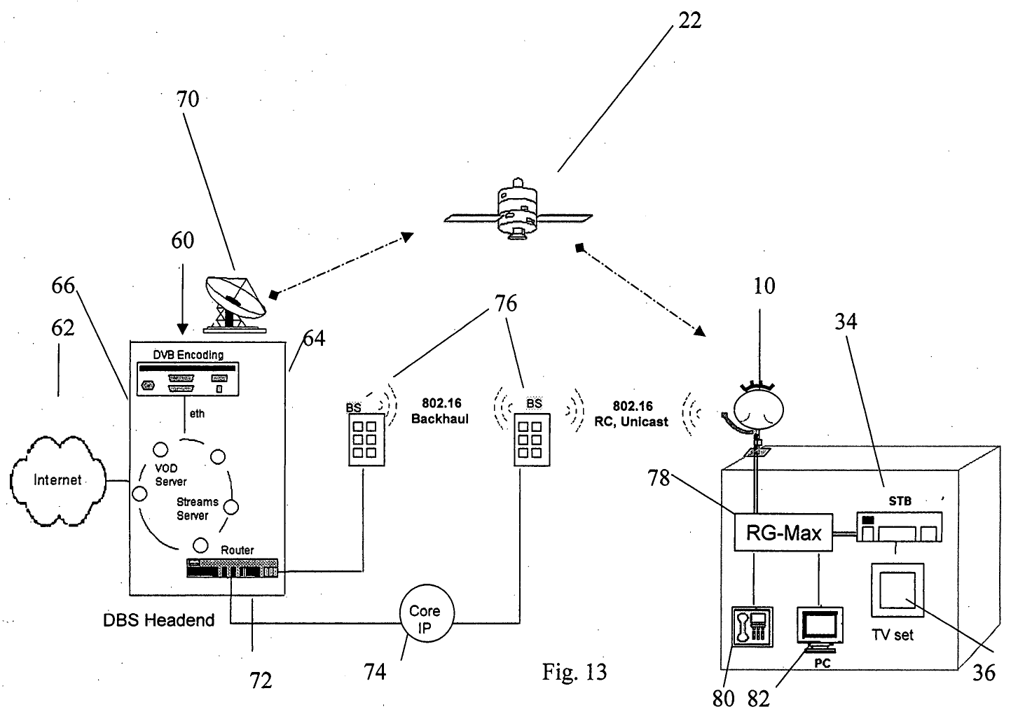

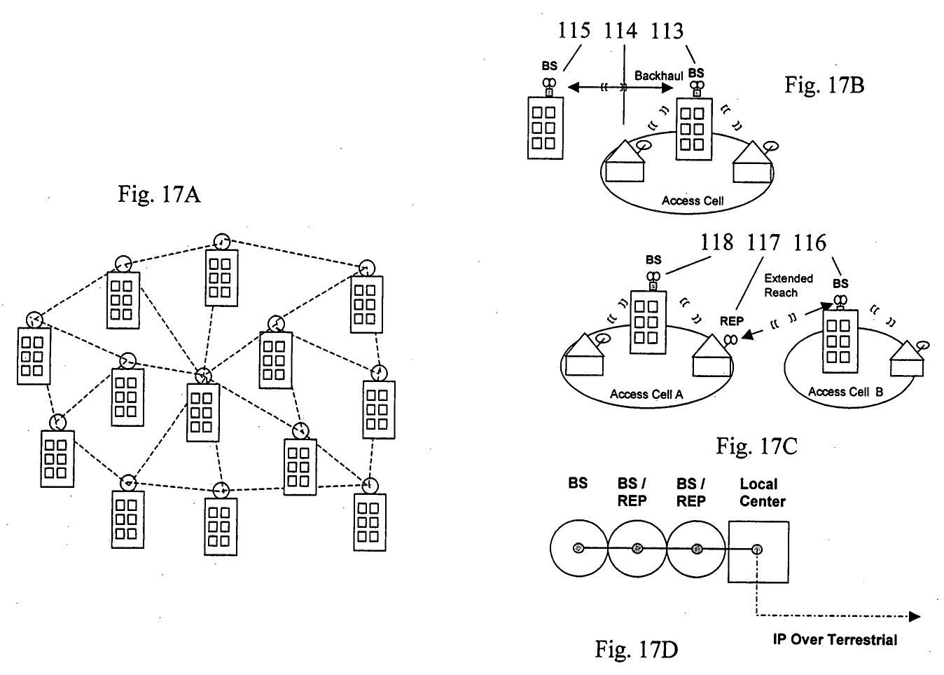

Reference is now made to FIG. 13, which is a simplified schematic diagram showing a broadcast system for supporting a one-way channel feed via satellite together with a two-way channel system via a WAN. Parts that are the same as in previous figures are given the same reference numerals and are not referred to again except as necessary for understanding the present embodiment. A transmission station or DBS head end 60 is connected to the Internet 62 and transmits a multi-channel TV feed via satellite to the users. In addition the head end receives the WAN-based return channel and also transmits an outward channel over the WAN to provide unicast signals to individual users. The head end comprises a series of servers such as a streaming server 64 which provides the TV channels and a video on demand (VOD) server 66 which provides individual video streams to individual customers who request it. Other servers (not shown) provide other services such as Internet, voice over IP and Interactive TV and the like that it is desired to provide to users. The TV channels are encoded for digital video broadcast (DVB) at DVB encoder 68 and sent via satellite antenna 70 and satellite relay 22 to all the users. Signals intended for the WAN are sent via router 72 and any suitable connection, typically some kind of core IP infrastructure 74, to WAN antennas 76 of which there is preferably one for each WAN. Return signals from the WAN are received at WAN antennas 76, sent back by the core IP infrastructure, received at router 72 and sent to the server providing the relevant service. The WAN signals are preferably sent on from user to user until arriving at the antenna 10 of the intended user, using point to multipoint and mesh type routing, as will be explained below in reference to FIG. 17.

Internet connections can also be local at a city concentrator and not only at the headend. Thus it is possible to provide a connection to a local ISP rather than a national ISP or to connect the VoIP to a local supplier rather then backhauling the entire data stream to the head end.

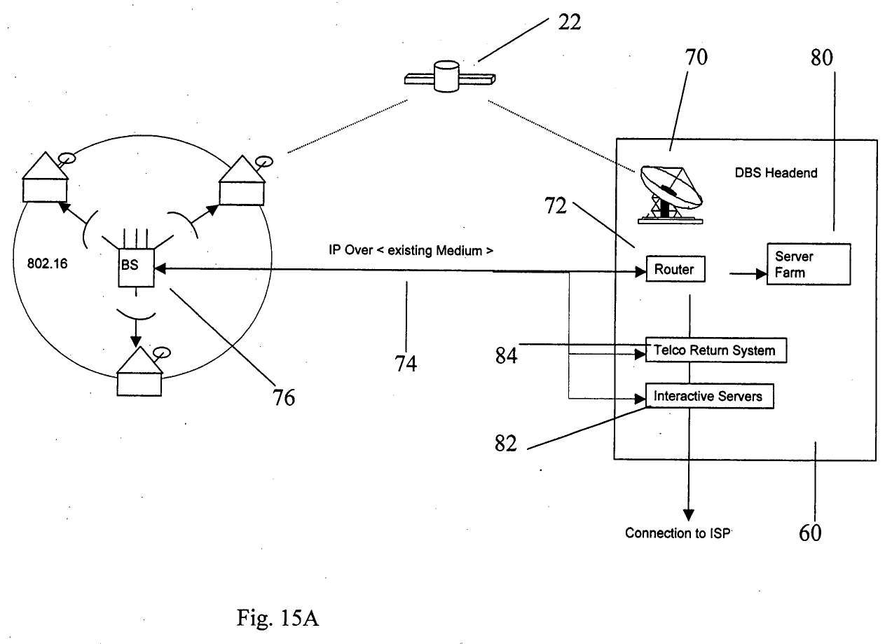

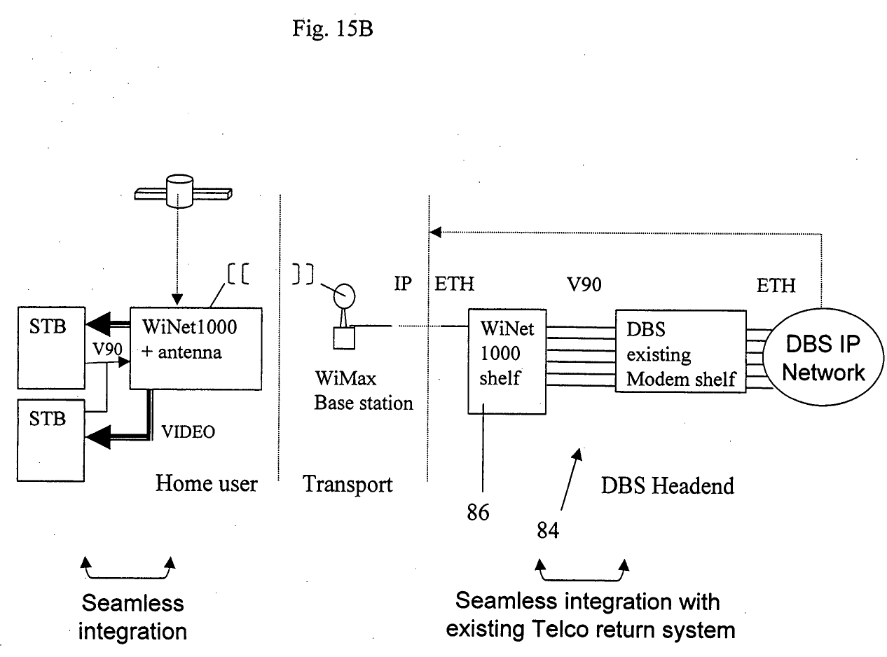

Units may thus be added at either or both of the city concentrator or the headend that can interface to existing infrastructure. For example it is possible to interface between the existing telco-return system and the WAN at the headend as shown in FIG. 15B. The user has filter combiners and a CPE as well as an STB as described above. In one embodiment the user has a residential gateway 78 which is a unit that acts as a household communications hub and is able to manage data routing to different communication devices in the house such as a voice over IP (VoIP) telephone 80 and a computer 82. In one preferred embodiment the residential gateway 78 supports a household LAN through which it is able to direct data to the different devices.

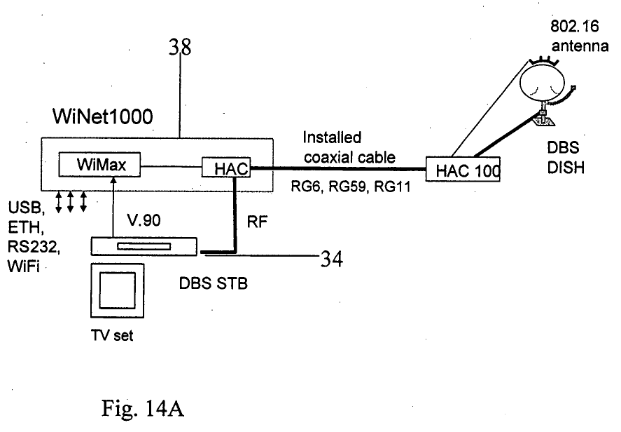

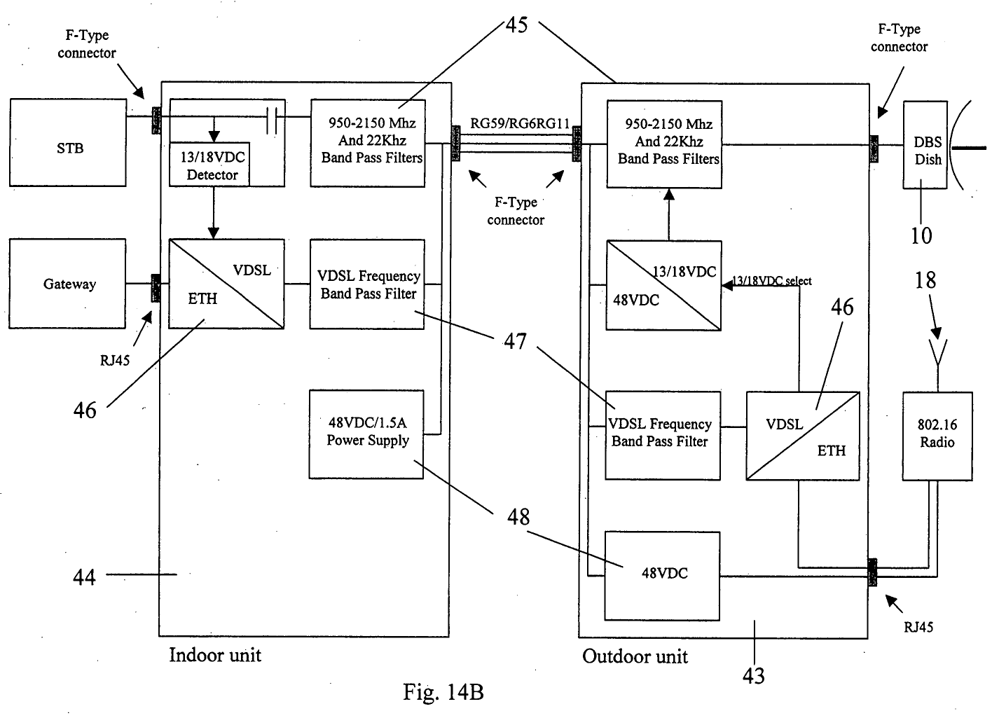

Reference is now made to FIG. 14A, which is a simplified diagram illustrating how the set top box 34 is connected up to an integrated splitter combiner and CPE unit 38 so that the TV receives the satellite signals for display and also has a return channel and a full-duplex unicast broadband connection via the WAN. In addition the TV is able to receive any video on demand or interactive TV signals that may be sent via the WAN. As shown in the figure the STB has an RF connection to the splitter combiner part of the unit 38 and a separate connection to the CPE part of the unit. The separate connection is preferably a V90 modem connection, but can also be a lower speed modem working say at 2400 b/s without V90 support. A separate connection is provided which can be any one of a range of connection types including a USB port, an RS232 port, an Ethernet port, a WiFi connection or any other suitable connection.

Reference is now made to FIG. 14B which is a simplified diagram illustrating a solution in which Ethernet is used as the distribution medium over the coax cable from the roof unit to the home and from the home gateway to the STBs. In FIG. 14B an outdoor unit 43 is connected to the satellite dish and WAN antenna. A coax cable connection links the indoor and outdoor units via bandpass filters 45. Both units have an Ethernet/VDSL unit 46, a VDSL bandpass filter 47, and suitable power supplies 48. The arrangement allows Ethernet distribution to be used between the outdoor and indoor units over the existing installed coax cable. A similar arrangement can be used to allow Ethernet distribution over existing in-house coax installation between the home gateway and the home STBs. With the same approach it is possible to distribute over an existing twisted pair installation as well. It will be appreciated that the use of Ethernet is merely an example, and the installation could also be designed to use IF and RF as the distribution medium.

Reference is now made to FIG. 15A, which shows in greater detail the DBS head end 60 and the WAN structure. Parts that are the same as in previous figures are given the same reference numerals and are not referred to again except as necessary for understanding the present embodiment. The DBS head end 60 is connected to one or more Internet service providers (ISP) through which users obtain their Internet services also can be mid-way at city concentrators. The DBS head end comprises router 72 and satellite antenna 70 as two separate routes for reaching users, as explained above with respect to FIG. 13. Server farm 80 provides data for the television and other services, although Interactive services may be provided by a separate bank of servers 82. A Telco (telephone based) return server 84 may be provided to retain compatibility with any persisting Telco return channel infrastructure. The telco infrastructure may or may not be provided with WAN-telco conversion units, which are a multi-card version of the CPE units to provide compatibility.

Router 72 leads over IP core 74, which is preferably an existing IP backbone type infrastructure to the WAN base stations 76. As illustrated a single WAN base station serves a group of users. In FIG. 15 a single WAN base station broadcasts directly to all users in the group, however this is not necessarily the case. As will be explained below, not all users need be in range of the main WAN base station and individual user installations may serve as relays or micro base stations to provide what is in effect a cellular network.

FIG. 15B shows in greater detail a configuration that retains existing telco functionality. In FIG. 15B the DBS IP network is connected to the Telco system 84 which in turn is directly connected to the WiNet 1000 shelf 86 which houses much of the system hardware for the WAN based channels.

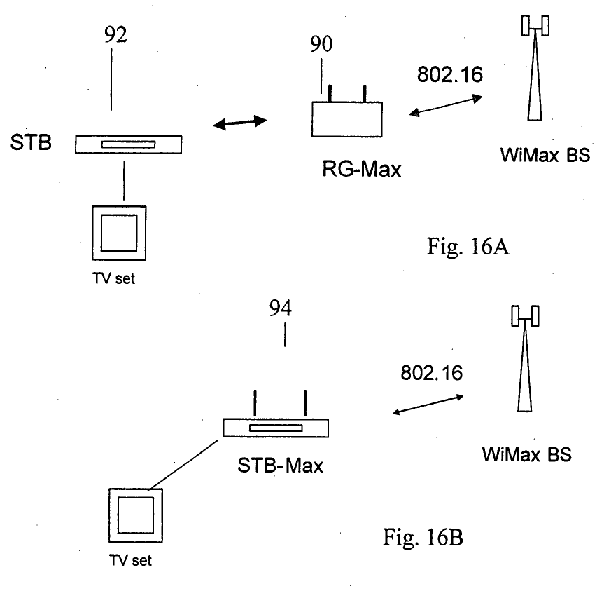

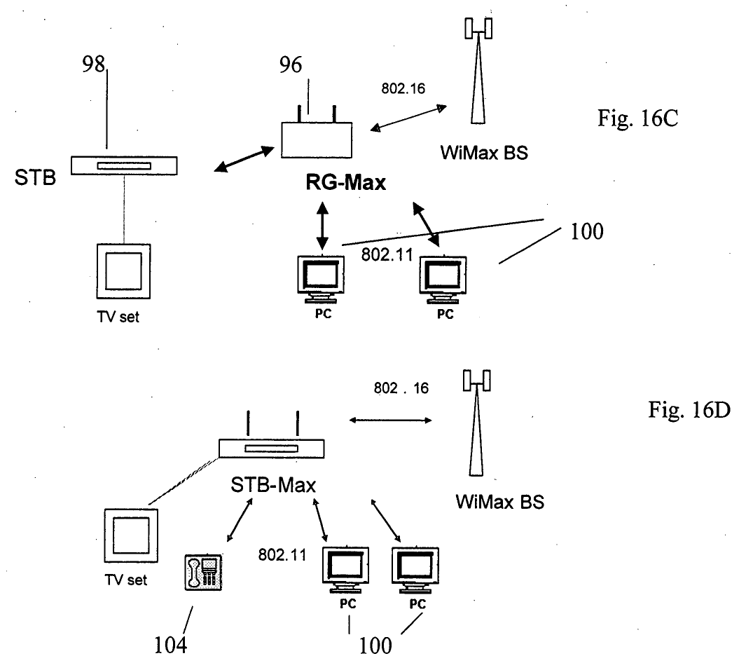

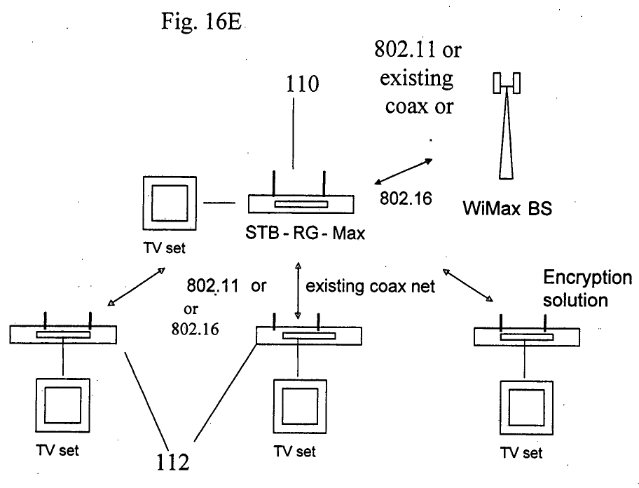

Reference is now made to FIGS. 16A-16E which are different configurations for the customer premises. In each of the figures a television is connected to the WAN/satellite infrastructure, and in some of the figures other devices are connected as well. In FIG. 16A a residential gateway unit 90 includes the electronics of the CPE discussed above and may be connected directly to STB 92. In FIG. 16B, STB 94 includes the CPE electronics and may be connected directly to the television. In FIG. 16C the residential gateway unit 96 is the same as in FIG. 16A and is connected to set top box 98 and additionally to other household devices such as computers 100. In FIG. 16D the combined set top box and residential gateway of FIG. 16B is connected directly to television 102 and other devices such as a telephone or a computer. In FIG. 16E a user having multiple television sets at his premises is accommodated by providing a single master STB 110 which includes the residential gateway and preferably the CPE electronics. The master STB is connected by existing cables to the user's additional television sets and standard STBs 112. In fact, communication between the master and additional STBs may use the 802.11 wireless standard, or the 802.16 standard or may use coaxial cable as the distribution medium.

Furthermore the distribution from the rooftop installation to the master STB may use the same range of distribution media.

The master STB's distribution function can be separated from the STB itself and a unit may be provided that serves as a distributor to all the home STBs via home networking (over WiFi, coax, or other Home PNA technique, or the like, depending on existing installed wiring such as coax and twisted pair).

Reference is now made to FIG. 17A, which is a simplified schematic diagram illustrating operation of the WAN. A number of satellite dishes are available in a given locality. The satellite dishes each act as relay stations providing a WAN network in which each node is able to communicate with any other node that is in range, hence providing mesh connectivity. Consequently the network can provide numerous alternative routes to any given user, making the WAN very robust and improving the available capacity. As discussed above, this involves enabling broadcasting over higher distances, at lower power.

Reference is now made to FIG. 17B which is a simplified diagram illustrating a configuration in which a first base station 113 feeds its own user stations 114, but also operates a backhaul link to a further base station 115. The configuration is particularly useful when core IP connections are not locally available or are not cost effective.

Reference is now made to FIG. 17C which is a simplified diagram illustrating an alternative configuration in which a backhaul connection is needed between a base station 116 and a base station 118 but there is not sufficient reach. The user station 117 is equipped with a repeater and acts as a relay for the backhaul channel, thus allowing an extended connection.

FIG. 17D is a simplified diagram illustrating a configuration in which core IP is used to supply a local center. The local center broadcasts via first and second repeaters to a base station. In this way minimal core IP connection is used and a local center feeds a number of base stations irrespective of the range, provided that a sufficient number of relays are available.

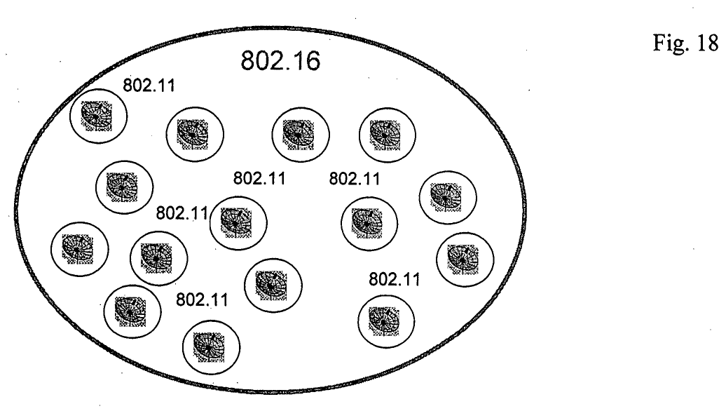

Reference is now made to FIG. 18, which is a simplified diagram showing how the network of FIG. 17 can be used to provide hotspot coverage. In the figure, the IEEE 802.16 standard provides the WAN, whilst the IEEE 802.11 standard, which defines hot spots, provides short range but high capacity coverage around each separate micro-base station. Thus high capacity Internet can be provided within the hotspots to anyone with a device that is able to log in successfully. The WAN is thus able to supplement local cellular networks with a data capacity level which the cellular networks are simply unable to provide. Furthermore, if the density of micro-base stations is high enough then the WAN can replace the cellular networks altogether. Thus there is provided the ability for the DBS operator to operate a mobile network over its DISH infrastructure, using 802.16e or 802.20.

The conversion of the satellite antenna as described herein enables a transformation of the current installed location into a 802.11 WiFi hotspot. The 802.16 WAN cloud thus serves as a backdrop to a series of WiFi hotspots. Transition between 802.11 and 802.16 operation is part of the 802.16 standard and is preferably carried out in accordance with the standard.

The use of the topologies described in FIGS. 17 and 18 create a highly dense mesh network, enabling a lowering of the cost of base station installation, transmission at lower power in every location, optional routing paths that can increase the utilization of infrastructure, and furthermore, the addition of hotspot technology may serve as the base structure for a future mobile network.

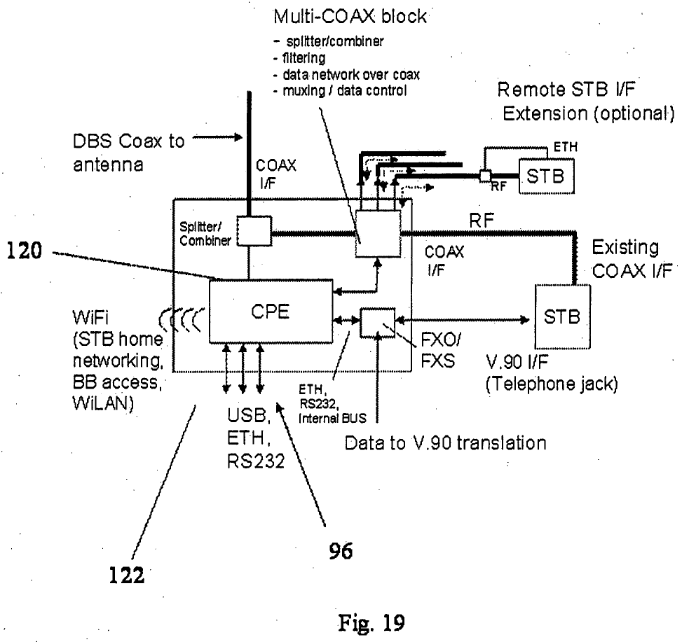

Reference is now made to FIG. 19, which is a simplified block diagram illustrating the components of combined CPE and splitter combiner 32 as illustrated in FIG. 3. As will be recalled, the combined unit 32 combines the functions of the splitter combiner and the CPE. As shown in FIG. 19, the gateway 96 includes splitter combiner unit 120 and CPE unit 122, the latter providing management for the WAN standard and if relevant the hotspot standard. The residential gateway is provided with interfaces for a LAN and direct interfaces for STBs and different kinds of ports. The splitter combiner unit 120 is connected to the co-ax cable that leads to the satellite antenna installation.

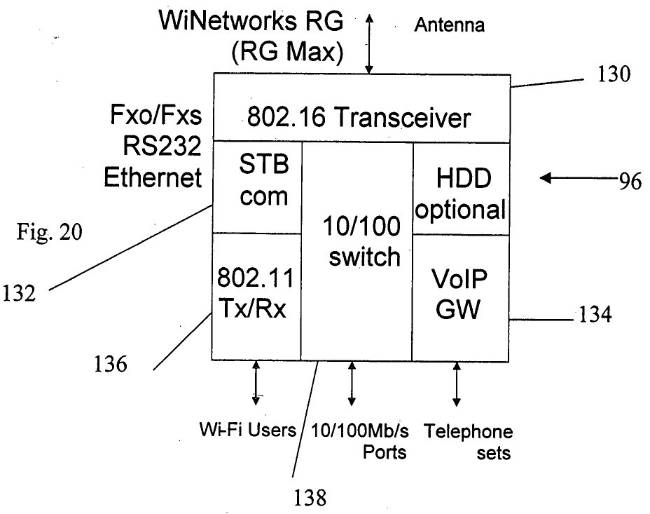

FIG. 20 is a system diagram showing the various components of the residential gateway 96 from a system point of view. An 802.16 transceiver unit 130 provides an interface to the WAN for the incoming, outgoing and relay WAN traffic. A set top box interface 132 provides an interface for one or more STBs. A voice over IP gateway 134 provides an Interface for telephones. An 802.11 interface 136 allows a connection for any 802.11 compatible device so as to set up a local hotspot. A 10/100 switch 138 provides connectivity for 10 and 100 Mb/s ports. The residential gateway can be connected directly to a LAN if desired.

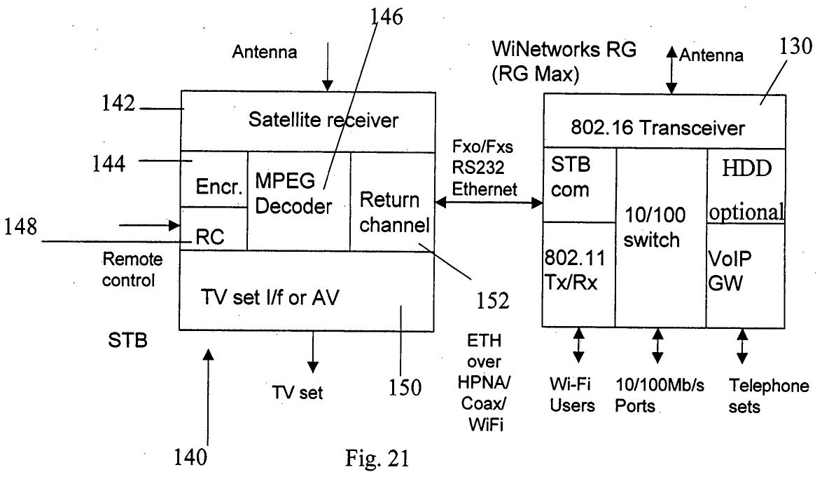

Reference is now made to FIG. 21, which is a simplified diagram showing the residential gateway 96 connected to STB 140. STB 140 is also shown from a system point of view. The STB has a direct receiver 142 for the incoming satellite signal which does not need to be relayed through the gateway. An encryption unit 144 deals with any encryption issues of the signal and an MPEG unit 146 carries out MPEG decoding. RC unit 148 is an interface for a remote control and a tuner 150 carries out standard interface functions for the TV set. Return channel unit 152 is an interface to the gateway 96 and provides the TV set with a return channel and a connection in general to the WAN part of the system. The system mimics the operation of the telco return channel to the installed STB, and thus provides seamless integration between the new and legacy systems.

Returning to encryption unit 144, streaming and other content is currently protected by encryption. The present embodiments are integrated to the existing satellite TV solutions for encryption. Thus the user requests the protected content in the usual way, via his remote control used interactively with the screen. The request from the user arrives from the Remote control to the STB, where it is analyzed. After this first analysis the request is sent by the Return channel to an Authentication sub-system at the Head end. After a second analysis, possibly including a check on billing policy for the current user, an encryption key is produced and sent to the user via a downstream channel which may be either Satellite or WAN to the STB and partially to the Residential Gateway, this part by WAN. The encrypted content is then sent by the WAN to the Residential Gateway where it may be stored, if storage is available, or streamed directly. The encrypted content is then opened by the STB. User commands for playing the content, such as Pause, Fast Forward, etc, may be sent to the RG or to the head-end VOD server. The content if stored, may be saved or erased from the RG according to system policy. The data storage can thus provide a PVR function for a legacy STB.

It is noted that simple routing functions (dynamic host configuration protocol (DHCP), NAT) and VoIP functions are also embedded.

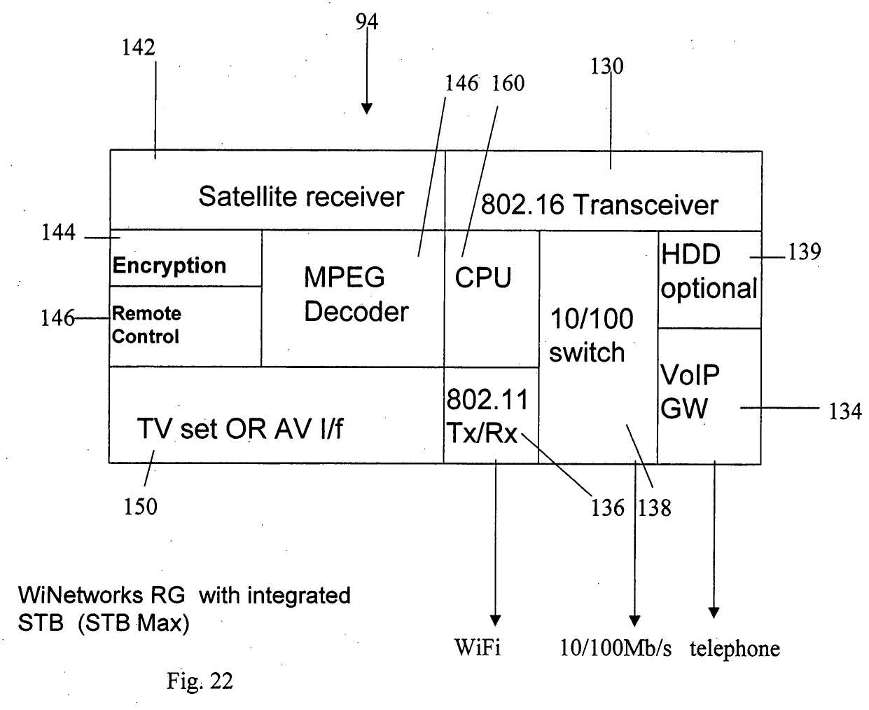

Reference is now made to FIG. 22, which is a simplified system diagram of the combined STB and residential gateway unit 94 of FIGS. 16B and D. Parts that are the same as in previous figures are given the same reference numerals and are not referred to again except as necessary for understanding the present embodiment. The device is a combination of the devices of FIGS. 20 and 21, except that the interfaces between the STB and the residential gateway are no longer required. Instead a CPU 160 is provided for overall control. A hard disk drive 139 is provided for data storage. The hard disk drive may in fact be provided in any of the embodiments and allows for content to be downloaded and then stored at a later time.

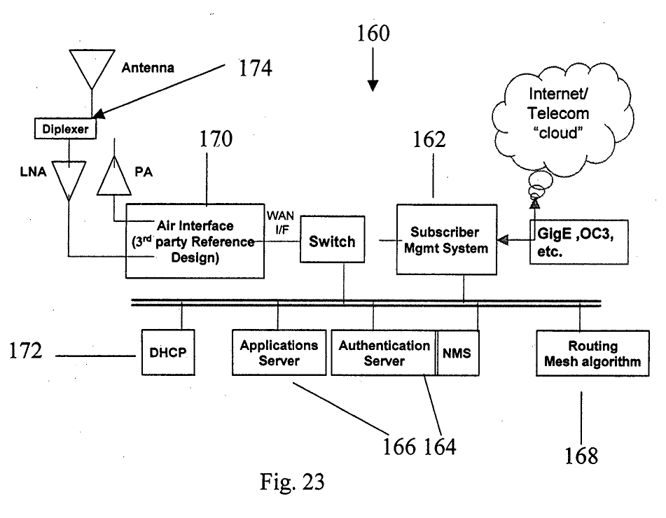

Reference is now made to FIG. 23, which is a system diagram of a WAN base station suitable for supporting antennas 76 at each WAN. The base station comprises a connection to the core IP infrastructure through which data is transferred to and from the transmission center. The infrastructure is here denoted as “internet telecom cloud” to indicate that any available infrastructure may be used that can support the kind of data and the quantity of data that needs to be transferred. The base station includes a subscriber management system 162 that carries out subscriber management tasks such as determining whether a particular service is available to the given subscriber and the like. An authentication server 164 and an application server 166 are also provided, as is a mesh algorithm unit 168 which deals with issues such as routing over the network. As will be recalled, the base station operates as a point to multipoint transmitter to reach users in the WAN, but as shown in FIG. 17 mesh type relaying of data is also supported and the mesh algorithm unit provides the support for such a function.

An air interface unit 170 transforms the incoming data into a signal that can be transmitted. DHCP 172 allows for automatic assignment of IP addresses for a LAN. Finally a transmission arrangement 174 of amplifiers, duplexers and antenna physically allows the signal to be transmitted.

An alternative design of the base station is a construction of roof-top units connected with an integral or external IP switch, thus serving as a flat and low cost base station structure.

With the present embodiment a satellite operator is able to use terrestrial broadcast technology over a WAN, such as a network based on the IEEE 802.16 or 802.20 standards, in order to support return channel and unicast functionality and services and to become a full multiple service provider to compete with the cable companies.

More specifically the present embodiments enable the DBS operator to provide such broadcast services as a return channel via unlicensed or licensed wireless networks for interactive applications. Also the embodiments can provide unicast services such as IP telephony, video on demand (VOD), Internet access, games on demand, multi-user gaming and more.

The infrastructure described herein can be expanded to mobile voice and data services if, as described above in respect of FIG. 18, each WAN unit and antenna is also used to provide a 802.16e or 802.20 mobile user access or alternatively can support a local hotspot service, for example using the IEEE 802.11 standard.

The WAN or Wimax network is an add-on to the existing satellite based digital broadcasting network to close the loop from the end-user to the DBS headend.

The Wimax network section is constructed using a base-station and DBS/CPEs as described above.

The return and unicast link between the end-user and the headend is packet-based and is transmitted firstly over existing core IP infrastructure to a WAN base station and then by wireless over the WAN, as discussed above in respect of FIG. 13.

The Wimax network is seamlessly connected to the existing DBS network through router 72 at head end 60.

Existing STBs do not have to be adapted, and instead can be connected to a separate residential gateway using such interfacing as a V90 I/F with seamless interface to the CPE or Wimax unit. For those existing set top boxes which include a modem for a telephone return channel the CPE can be configured to support of rings and analog levels, thereby mimicking the telephone link. The gateway preferably includes a UART interface—RS232, a USB interface, or an Ethernet/Fast Ethernet interface, as described above.

As explained, it is also possible to provide an integrated STB with full residential gateway capabilities and Wimax capabilities.

For customers who require, it is possible to provide a Residential Gateway Minimal application, which is nothing more than an uplink for the set top box. The uplink, or return channel, enables the STB to support interactive commands, gaming, interactive TV/games but does not allow for any services that require unicast.

A return channel only application has minimal bandwidth usage, and enables a satellite provider to start with a bare minimal base-station infrastructure and relatively large cell sizes. The provider may then add more base stations only as more services and more users are added and more revenues are generated.

A more sophisticated version of the residential gateway includes a downlink via the WAN which enables the STB to directly support dedicated traffic such as video on demand, gaming on demand and the like.

As described above in respect of FIG. 16B it is possible to expanding the STB capabilities to include the Residential Gateway. Such a combined device supports high speed Internet access by the satellite TV provider, hot-spot support with integrated WiFi, video on demand, interactive games, etc, as well as interactive TV.

Extending the Residential Gateway capabilities as shown in FIG. 16C provides the additional services of a full Residential Gateway including a VoIP Telephone service provided by the satellite provider. An extended Residential Gateway may contain additional functions such as Personalized Video Recording—PVR (virtual or included disk) voice mail and the like.

End user unit antennae for the WAN has been described up till now as being located with the satellite dish. However this is not essential and in certain embodiments the WAN antenna may be located internally by the end-user device although this results in short reach. For cases in which there is a high density of satellite users such short reach may be sufficient. An external window antenna may be provided for improved or extended reach, and a roof antenna may be located over the existing satellite antenna mount, as described above, to give maximum possible reach. In such a case, as described above, the existing connection infrastructure at the user premises is used wherever possible, and the connection from the antenna to the end-unit is over the existing coax cable.

The electronics to provide Wimax-TV inter-signal interference suppression are provided. The Wimax base-station supports point-to-multi-point and MESH-type routing over the WAN. In a preferred embodiment there is also support for mobile telephony devices. The use of Mesh topology allows more bandwidth and better coverage.

The MESH topology and the use of the satellite receiver infrastructure enables the satellite TV provider to maximize his infrastructure and right of way.

In such a mesh transmission mode, some of the users become relays or micro base stations and improve network coverage. There are more pathways over the network and there is better usage of the installed satellite receiver infrastructure.

By adding mobile support over the created wireless data infrastructure the satellite TV provider is able to enhance his services and offer services to nomadic or mobile users.

As shown in FIG. 18, every roof-top antenna may become a hot-spot for nomadic users if desired.

The satellite TV provider may thus compete with cellular operators and offer mobile VoIP voice services. The satellite TV provider also becomes a provider of multiple services and the customers benefit by having a single bill for all of these services.

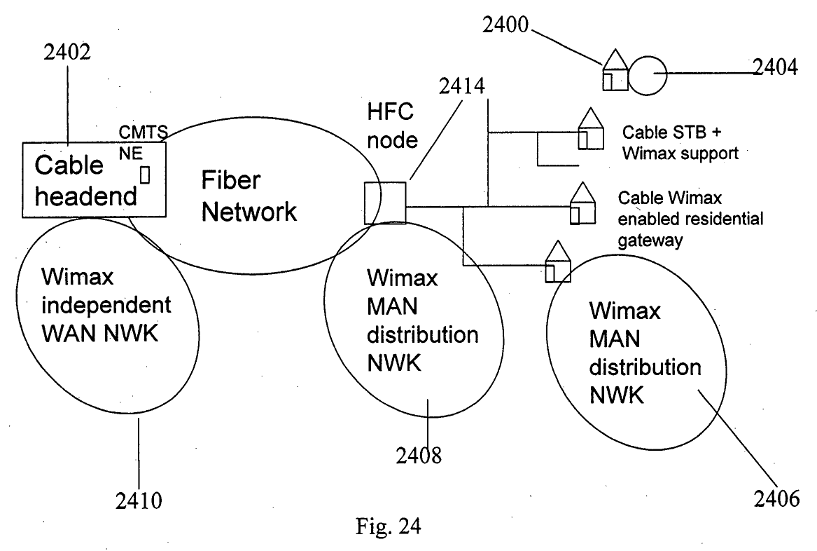

Reference is now made to FIG. 24, which illustrates the construction of a coax based network over which WiMax may be applied. The figure illustrates a number of different regions between the user 2400 and the head end 2402, any or all of which may use coax.

The regions are as follows:
1. From the cable modem to the roof, for the purpose of delivering a WiMAx service using the coax infrastructure
2. From a Wimax supporting Cable STB to the supported home devices 2408
3. Local distribution delivering wimax over cable coax in addition to existing signals 2410, and
4. As a totally separate delivery network from the headend 2412.

In addition, coax may be used for any part of the route from the headend to the user, such as from a fiber or hybrid node 2414, or from a coax node (such as the home units). WiMax support can be integrated in the cable STBs or may be a separate residential gateway connecting to the Cable coax network. Wiamx support can be local (an NLOS embedded antenna) or via an external antenna.

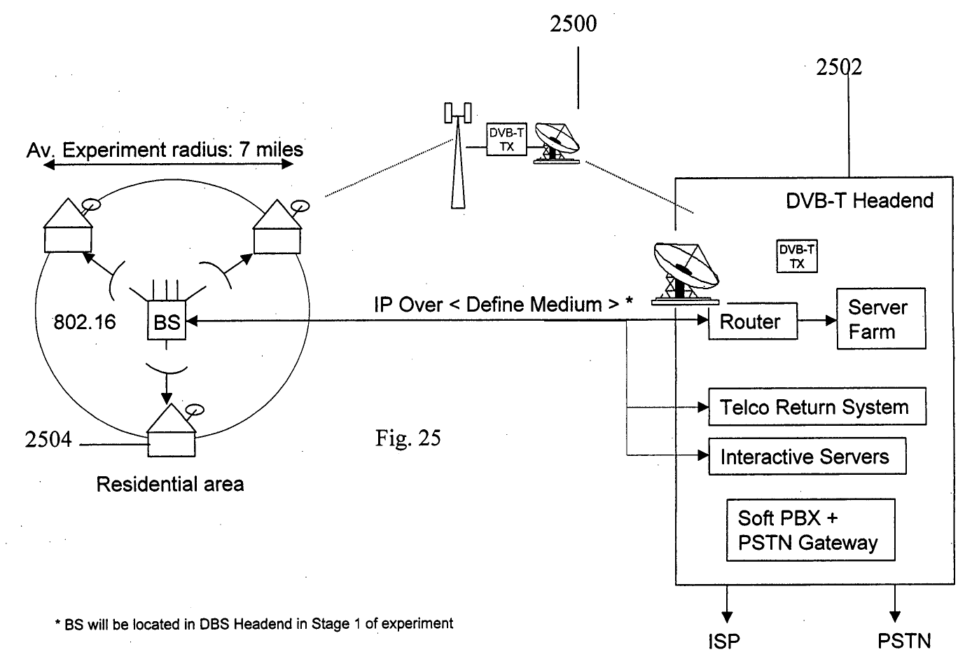

Reference is now made to FIG. 25, which is a simplified schematic diagram illustrating the general outline for providing an interactive system according to the present embodiments when the outward broadcast channel is provided using conventional terrestrial broadcasting (DVB-T). As shown in FIG. 25, an outward broadcast leg 2500 is sent via terrestrial transmitters from a head end 2502 to users 2504. The return/interactive/unicast leg is sent via a WAN 2506 and undefined media 2508.

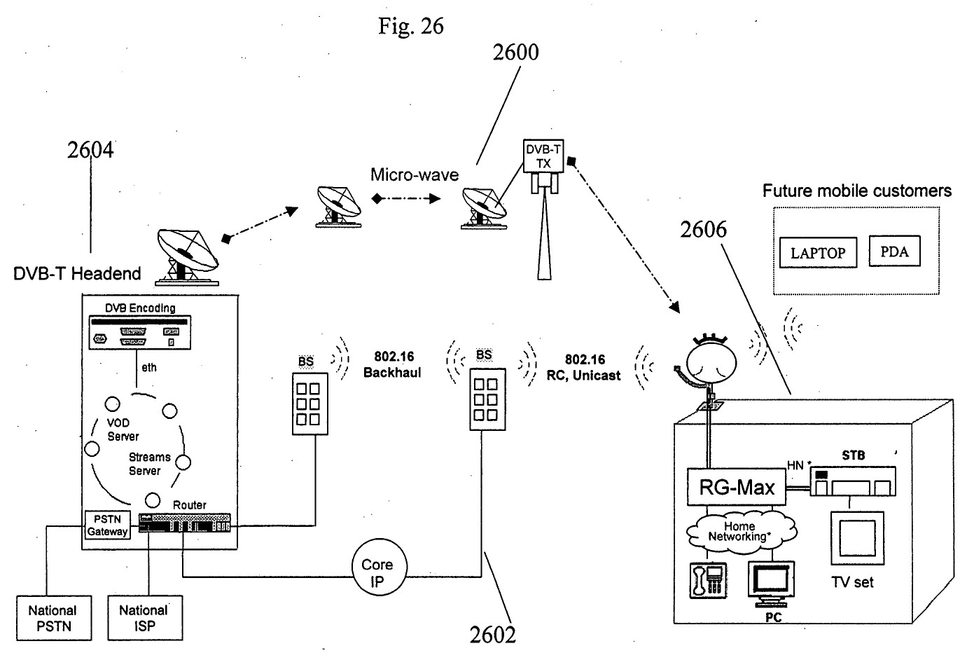

Reference is now made to FIG. 26, which shows a hybrid wireless digital video broadcast network in which an outward broadcast leg 2600 uses terrestrial broadcasting (DVB-T) and a return channel, interactive and unicast services are supported via a WAN 2602 between a head end 2604 and user 2606.

It is expected that during the life of this patent many relevant satellite TV and WAN devices and systems will be developed and the scopes of the terms herein, particularly of the terms “WAN”, “hot spot”, “and “satellite broadcast”, are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A wide area network for bi-directional transmission between a plurality of user nodes and a central source node, at least some of the user nodes comprising rooftop video broadcast receiving installations modified with a terrestrial bi-directional antenna and network transmission support electronics.

2. The wide area network of claim 1, wherein at least some of said user nodes comprise support for hotspot functionality, thereby to allow mobile communication devices to access said wide area network system.

3. The wide area network of claim 2, wherein said support for hotspot functionality substantially comprises standard IEEE 802.11.

4. The wide area network of claim 1, wherein said rooftop video broadcast receiving installations are satellite receiving installations.

5. The wide area network of claim 1, wherein said rooftop video broadcast receiving installations are terrestrial broadcast receiving installations.

6. A wide area network system, comprising:
a central source node,
a plurality of base nodes connected via cable infrastructure to said central node, and
a plurality of user nodes, at least some of the user nodes comprising rooftop video broadcast receiving installations modified with a terrestrial bi-directional antenna and network transmission support electronics.

7. The wide area network system of claim 6, wherein the cable infrastructure is hybrid fiber coax (HFC) infrastructure.

8. The wide area network system of claim 6, wherein a wide area network transmission standard is used over said cable infrastructure.

9. The wide area network system of claim 8; where said transmission standard is at least one of IEEE 802.16 standard or the IEEE 802.20 standard.

10. The wide area network system of claim 6, wherein at least some of said user nodes comprise support for hotspot functionality, thereby to allow mobile communication devices to access said wide area network system.

11. The wide area network system of claim 10, wherein said support for hotspot functionality substantially conforms to IEEE standard 802.11.

12. The wide area network system of claim 6, wherein said rooftop video broadcast receiving installations are satellite receiving installations.

13. The wide area network system of claim 6, wherein said rooftop video broadcast receiving installations are terrestrial broadcast receiving installations.

14. A hybrid cable and wireless bidirectional transmission network comprising a wireless network part and a cable part and wherein a wide area network transmission standard is used over both said wireless network part and said cable part.

15. The hybrid cable and wireless bidirectional transmission network of claim 14, wherein said transmission standard is at least one of IEEE 802.16 standard or the IEEE 802.20 standard.
